(19) United States
(12) Patent Application Publication
(10) Pub. No.: US 2001/0038685 A1
(43) Pub. Date: Nov. 8, 2001

(54) TELEPHONE CONTROL VIA AN EXTERNAL CONTACT CLOSURE

(76) Inventors: MICHAEL GLEN DUNCAN, AUSTIN, TX (US); RONALD ALBERT KUBENA, ROUND ROCK, TX (US)

Correspondence Address: SIEMENS CORPORATION, INTELLECTUAL PROPERTY DEPARTMENT, 186 WOOD AVENUE SOUTH, ISELIN, NJ, 08830

(21) Appl. No.: 08/851,844

(22) Filed: May 6, 1997

(51) Int. Cl. H04M 11/04

(52) U.S. Cl. 379/40; 379/44

(57) ABSTRACT

A telephone is controlled using an external contact closure. The telephone includes a contact closure connector. The contact closure connector includes a first wire contact and a second wire contact. Control logic is connected to the first wire contact and the second wire contact. The control logic detects a change in electrical connection between the first wire contact and the second wire contact. Alternatively, the control logic detects a change in electrical connection between multiple pairs of wire contacts. In response to the change in electrical connection, the control logic issues a command to a processor connected to the control logic. The processor, upon receipt of the command issued by the control logic, implements a predetermined telephone function or set of functions.

### BACKGROUND

1. Field of the Invention

The present invention concerns telephone systems and pertains particularly to using an external contact closure to control a telephone.

2. Related Information

Telephones provide powerful communication links between people. By merely entering a particular sequence of numbers on a keypad, a telephone can be immediately connected with locations throughout the world. While a telephone keypad is currently the standard user interface, there are often interactions with a telephone which would be best served by another type of interface.

One telephone interface which is increasingly used is an application programmer's interface (API). A telephone generally implements an application programmer's interface (API) using an API control port. Typically, however, API control ports are very expensive and require a complex phone configuration/setup and/or complex cabling. Additionally, an external device connected to an API control port has to have sufficient intelligence to interact with the API control port. In general, API is used for true computer telephone integration (CTI) applications which require considerable set-up and programming.

Many users do not need the complex functions implemented by an API, but could use targeted control for particular circumstances. What is needed is a reliable, simplified means for control of specific telephone features.

### SUMMARY OF THE INVENTION

In accordance with the preferred embodiment of the present invention, a telephone is controlled using an external contact closure. The telephone includes a contact closure connector. The contact closure connector includes a first wire contact and a second wire contact. Control logic is connected to the first wire contact and the second wire contact. The control logic detects a change in electrical connection between the first wire contact and the second wire contact. In response to the change in electrical connection, the control logic issues a command to a processor connected to it. The processor, upon receipt of the command issued by the control logic, implements a predetermined telephone function.

The present invention provides an efficient and low cost implementation for accessory control of a telephone. The implementation is reliable and can be used within an emergency system. Additionally, since the invention can be implemented within a private branch exchange (PBX) phone system, many of which are battery powered, various embodiments of the present invention can maintain functionality even during power outages.

### BRIEF DESCRIPTION OF THE DRAWINGS

FIG. 1 is a simplified block diagram of a telephone system which includes a contact closure accessory device in accordance with a preferred embodiment of the present invention.

FIG. 2 is a simplified block diagram of a telephone which includes control logic for detecting closure of contacts in accordance with a preferred embodiment of the present invention.

FIG. 3 is a simplified block diagram of a telephone which includes control logic for detecting closure of contacts in accordance with an alternative preferred embodiment of the present invention.

FIG. 4 is a flow chart of a method in accordance with the present invention.

### DESCRIPTION OF THE PREFERRED EMBODIMENTS

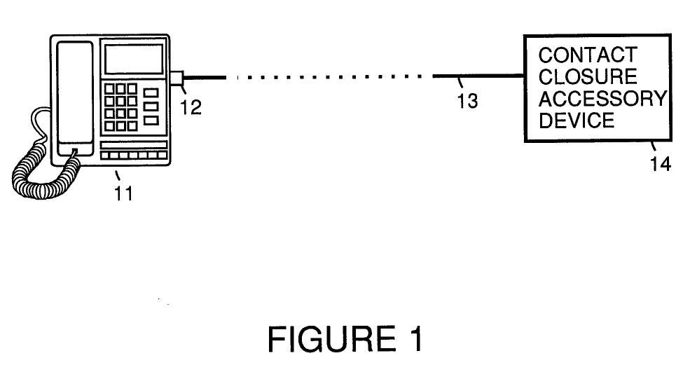

FIG. 1 is a simplified block diagram of a telephone system which includes a telephone 11 and a contact closure accessory device 14. Telephone 11 includes a contact closure connector 12. Contact closure connector 12 includes two wire contacts. Telephone 11 detects when electrical contact is made between the two wire contacts and/or when electrical contact is broken between the two wire contacts. For example, in one embodiment, telephone 11 performs a predetermined function when even temporary electrical contact is made between the two wire contacts of contact closure connector 12. In another embodiment, telephone 11 performs a predetermined function when electrical contact is (even temporarily) broken between the two wire contacts of contact closure connector 12.

The predetermined function performed by telephone 11 is, for example, simulating the pressing of a function key on a keypad of telephone 11, dialing a pre-programmed telephone number, going off-hook, or some other telephone function.

Contact closure accessory device 14 is connected to contact closure connector 12 via a connection line 13. Connection line 13 consists of, for example, two insulated electrically conductive wires. Each electrically conductive wire is connected to one of the wire contacts of contact closure 12. Contact closure accessory 14 is, for example, any device which provides for temporary connection or disconnection of the two insulated electrically conductive wires within connection line 13.

For example, contact closure accessory device 14 is a button switch which provides for temporary connection of the two insulated electrically conductive wires within connection line 13 when a button is pressed. Such a button switch is designed, for example, to be suitable to be placed in a hospital room for use by a patient to call a nurse. In this case, the predetermined function performed by telephone 11 is, for example, dialing a particular telephone number (or extension) of a central nurse station. Alternatively, the button switch is designed to be suitable to be placed close to a bank teller station for use by the bank teller in an emergency. In this case, the predetermined function performed by telephone 11 is, for example, dialing a particular emergency telephone number (or extension) to alert officials of an emergency situation.

Alternatively, contact closure accessory device 14 is, for example, a switch wired to a secure door or a secure window. When the secure door or secure window is opened (or closed) contact closure accessory device 14 disconnects (or connects) the two insulated electrically conductive wires within connection line 13. In this case, the predetermined function performed by telephone 11 upon detecting the disconnection (or connection) is, for example, dialing a particular telephone number (or extension) of a central security station.

Alternatively, contact closure accessory device 14 is, for example, a fire alarm or a power-fail detector. When the fire alarm or the power-fail detector detects a fire or power failure, contact closure accessory device 14 disconnects (or connects) the two insulated electrically conductive wires within connection line 13. In this case, the predetermined function performed by telephone 11 upon detecting the disconnection (or connection) is, for example, dialing a particular emergency telephone number (or extension).

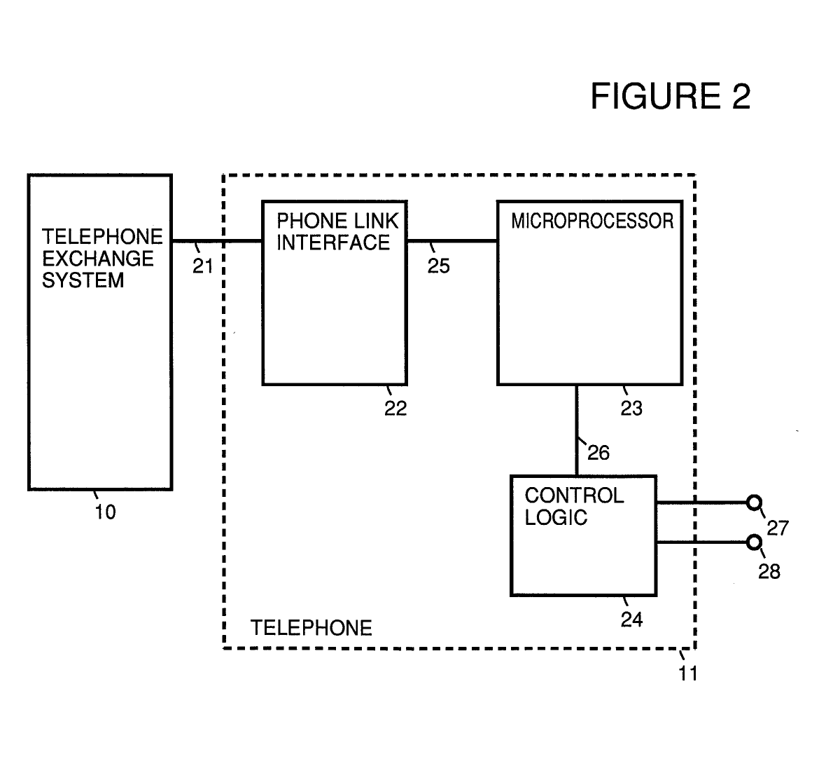

FIG. 2 is a simplified block diagram of telephone 11. Telephone 11 includes a phone link interface 22 connected to a phone line 21. Phone link interface 22 provides communication to a telephone exchange system 10. Telephone exchange system 10 is, for example, a private branch exchange (PBX) or a central office switch. For example, phone link interface 22 interfaces with telephone exchange system 10 using an analog connection, a digital connection, or an integrated services digital network (ISDN) connection.

A microprocessor 23 acts to control operations within telephone 11. Microprocessor 23 communicates with phone link interface via a connection link 25.

Control logic 24 monitors a contact closure contact 27 and a contact closure contact 28. In one embodiment of the present invention, when control logic 24 detects electrical connection between contact closure contact 27 and contact closure contact 28, control logic 24 passes a command over a control bus 26. In an alternative embodiment of the present invention, when control logic 24 detects electrical disconnection between contact closure contact 27 and contact closure contact 28, control logic 24 passes a command over control bus 26.

When microprocessor 23 receives the command from control logic 24, microprocessor 23, depending upon implementation, either executes the command or forwards the command via phone link interface 22 for execution by telephone exchange system 10.

For example, upon control logic 24 detecting electrical connection between contact closure contact 27 and contact closure contact 28, control logic 24 passes a command over a control bus 26 which indicates that the connection has taken place. In response to this command, microprocessor 23 forwards to telephone exchange system 10 a series of keystrokes which include a telephone number or other code. Alternatively, in response to the command, microprocessor 23 forwards to telephone exchange system 10 one or more feature key keystrokes. The telephone exchange then performs whatever feature is associated with the feature key. Alternatively, in response to the command from control logic 24, microprocessor 23 performs whatever feature is associated with a feature key.

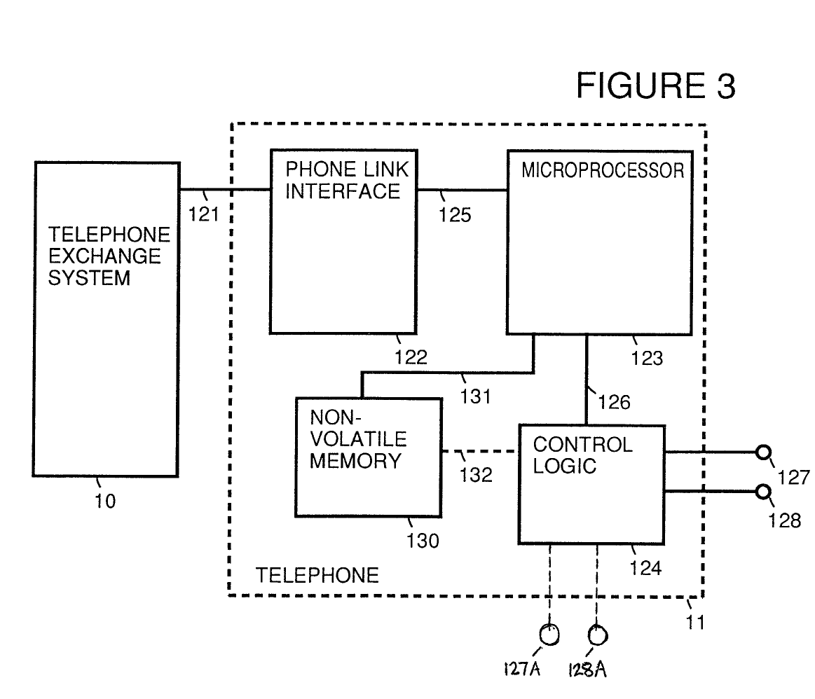

FIG. 3 is a simplified block diagram of an alternative embodiment of telephone 11. Telephone 11 includes a phone link interface 122 connected to a phone line 121. Phone link interface 122 provides communication to telephone exchange system 10. For example, phone link interface 122 interfaces with telephone exchange system 10 using an analog connection, a digital connection, or an integrated services digital network (ISDN) connection. A microprocessor 123 acts to control operations within telephone 11. Microprocessor 123 communicates with phone link interface via a connection link 125.

Control logic 124 monitors a contact closure contact 127 and a contact closure contact 128. In one embodiment of the present invention, when control logic 124 detects electrical connection between contact closure contact 127 and contact closure contact 128, control logic 124 passes a command over a control bus 126. In an alternative embodiment of the present invention, when control logic 124 detects electrical disconnection between contact closure contact 127 and contact closure contact 128, control logic 124 passes a command over control bus 126.

When microprocessor 123 receives a command from control logic 124, the microprocessor accesses a function associated with the command from a non-volatile memory 130 via a control bus. The microprocessor then executes the function. For example, microprocessor 123 executes the function by forwarding to telephone exchange system 10 a series of keystrokes which form a telephone number. Alternatively, microprocessor 123 can execute the function by forwarding to telephone exchange system 10 one or more feature key keystrokes.

The advantage of using non-volatile memory 130 is that the function is stored in non-volatile memory and thus is both programmable and yet is not lost when telephone 11 is reset or loses power.

As illustrated by an alternative access route 132, the function may be accessed by control logic 124 rather than microprocessor 123. In this embodiment, control logic 124, upon connection (or disconnection) of contact closure contacts 127 and 128, forwards the function to microprocessor 123. Microprocessor 123 either performs the function or forwards the function, via phone link interface 122, to telephone exchange system 10.

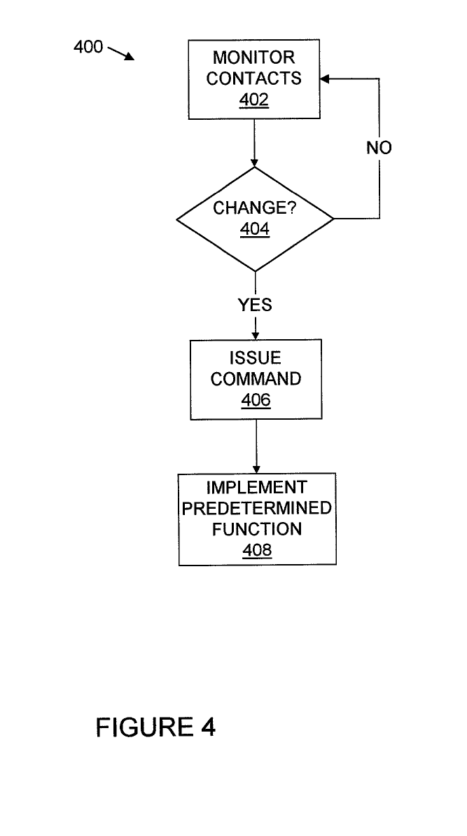

In either embodiment as shown in FIGS. 2 and 3, more than one pair of contacts can be used. Accordingly, more than one function can be implemented. A second pair of contacts is schematically shown in FIG. 4 as contacts 127A and 128A. The second pair is shown in dashed lines to indicate that they are optional.

FIG. 4 illustrates a method 400 in accordance with the present invention. Control logic within a telephone monitors, at a step 402, first and second wire contacts to detect changes in electrical connection. If a change is detected, at a step 404, the control logic issues, at a step 406, a command to a processor within the telephone. Upon receiving the command, the processor implements, at a step 408, a predetermined telephone function, as for example, the telephone going off hook or dialing a number.

Although particular embodiments of the invention have been shown and described, it is understood that various modifications are possible within the spirit and scope of the invention, the scope of which is limited only by the following claims.

What is claimed is:

1. A telephone comprising:
a contact closure connector, the contact closure connector including a first wire contact and a second wire contact;
control logic, connected to the first wire contact and the second wire contact, the control logic detecting a change in electrical connection between the first wire contact and the second wire contact, and in response to the change in electrical connection, issuing a command; and,
a processor, coupled to the control logic, which upon receipt of the command issued by the control logic, implements a predetermined telephone function.

2. A telephone as in claim 1 wherein the contact closure connector is connected to a contact closure accessory device, the contact closure accessory device being one of a button switch, a switch wired to a secure window/door in a building and an alarm system.

3. A telephone as in claim 1 wherein the control logic detects when electrical connection is made between the first wire contact and the second wire contact.

4. A telephone as in claim 1 wherein the control logic detects when electrical connection between the first wire contact and the second wire contact is broken.

5. A telephone as in claim 1 wherein the predetermined telephone function is the telephone going off hook.

6. A telephone as in claim 1 wherein the predetermined telephone function is an equivalent of pressing a function key on a keypad of the telephone.

7. A telephone as in claim 1 wherein the predetermined telephone function is dialing a pre-programmed telephone number.

8. A telephone as in claim 1 additionally comprising a non-volatile memory in which is stored the predetermined telephone function.

9. A telephone as in claim 1 further comprising a second contact closure connector including a third wire contact and a fourth wire contact.

10. A telephone as in claim 9 in which the second contact closure connector is connected in parallel with the first contact closure connector.

11. A telephone as in claim 9 in which more than one predetermined telephone function is implemented.

12. A method comprising:
(a) monitoring, by control logic within a telephone, a contact closure connector including a first wire contact and a second wire contact, in order to detect a change in electrical connection between the first wire contact and the second wire contact;
(b) in response to detecting a change in electrical connection between the first wire contact and the second wire contact in step (a), issuing a command from the control logic to a processor within the telephone; and,
(c) implementing a predetermined telephone function, by the processor, upon the processor receiving the command issued from the control logic.

13. A method as in claim 12 wherein in step (a) the contact closure connector is connected to one of a button switch, a switch wired to a secure window/door in a building and an alarm system.

14. A method as in claim 12 wherein in step (b) the control logic detects when electrical connection is made between the first wire contact and the second wire contact.

15. A method as in claim 12 wherein in step (b) the control logic detects when electrical connection between the first wire contact and the second wire contact is broken.

16. A method as in claim 12 wherein in step (c) the predetermined telephone function is the telephone going off-hook.

17. A method as in claim 12 wherein in step (c) the predetermined telephone function is an equivalent of pressing a function key on a keypad of the telephone.

18. A method as in claim 12 wherein step (c) includes accessing the predetermined telephone function from a non-volatile memory.

19. A method as in claim 12 wherein in step (c) the predetermined telephone function is dialing a pre-programmed telephone number.

20. A method as in claim 12 further comprising:
(d) monitoring a second contact closure connector, said second contact closure connector including a third wire contact and a fourth wire contact in order to detect a change in electrical connection between the third wire contact and the fourth wire contact;
(e) in response to detecting a change in electrical connection between the third wire contact and the fourth wire contact in step (d), issuing a second command from the control logic to a processor within the telephone; and,
(f) implementing a second predetermined telephone function, by the processor, upon the processor receiving the second command issued from the control logic.

21. A protection system comprising:
a telephone, including a contact closure connector, the contact closure connector including a first wire contact and a second wire contact,
control logic, connected to the first wire contact and the second wire contact, the control logic detecting a change in electrical connection between the first wire contact and the second wire contact, and in response to the change in electrical connection, issuing a command, and
a processor, coupled to the control logic, which upon receipt of the command issued by the control logic, implements a predetermined telephone function; and,
a contact closure accessory, coupled to the contact closure connector, which changes electrical connection between the first wire contact and the second wire contact.

22. A protection system as in claim 21 wherein the contact closure accessory is connected to a contact closure accessory device, the contact closure accessory device being one of a button switch, a switch wired to a secure window/door in a building and an alarm system.

23. A protection system as in claim 21 wherein the telephone additionally includes a non-volatile memory in which is stored the predetermined telephone function.

24. A protection system as in claim 21 wherein the predetermined telephone function is one of the following:
the telephone going off hook;
an equivalent of pressing a function key on a keypad of the telephone; and,
dialing a pre-programmed telephone number.
